(19) United States
(12) Patent Application Publication
(10) Pub. No.: US 2010/0086388 A1
(43) Pub. Date: Apr. 8, 2010

(54) System and Method for Oilfield Service Equipment Transportation and Placement

(76) Inventor: Mark Guidry, Lafayette, LA (US)

Correspondence Address: LAW OFFICE OF JESSE D. LAMBERT, L.L.C., 406 AUDUBON BLVD., LAFAYETTE, LA, 70503, US

(21) Appl. No.: 12/245,801

(22) Filed: Oct. 6, 2008

(51) Int. Cl. B60P 1/02

(52) U.S. Cl. 414/495

(57) ABSTRACT

A system for oilfield service equipment transportation and placement comprises a street-legal truck having a tool skid handling system and a tool skid. The tool skid may be offloaded from, and loaded onto, the truck, by means of the tool skid handling system, while requiring only a single person to carry out the loading or offloading. Preferably, the tool skid holds all specialized service equipment for carrying out a particular job at a wellsite, for example running a string of casing or other threaded connection tubulars. The tool skid handling system has a hydraulically powered arm with a hook on the end, and enables one person (namely, the driver of the truck) to load and offload the fully loaded tool skid with no additional assistance. Exemplary methods for using the system are also disclosed.

### CROSS REFERENCE TO RELATED APPLICATIONS

Not applicable.

### BACKGROUND

1. Field of the Invention

This invention relates to a system and method for the efficient transportation and placement of oilfield equipment. More particularly, this invention relates to an improved system and method of transporting, placement, handling, and deployment of equipment used in well servicing operations, including but not limited to tubular handling equipment such as power tongs, elevators and the like.

2. Related Art

Equipment of many varieties is needed during the course of drilling, completing and/or servicing an oil and/or gas well (referred to hereafter simply as a “well”). In addition to the drilling and/or completion or workover rig, other equipment is routinely brought onto the location (that is, the location where the well is being drilled or otherwise serviced) for relatively short term jobs as part of the overall drilling and completing of the well. Examples of such jobs include cementing of casing strings, acidizing, frac jobs, and the running of tubular goods into the well, especially casing.

Every well uses tubular goods, including drill pipe used in the actual drilling of the well, casing that is run and cemented into the earthen borehole, and production tubing run into the well through which oil and/or gas flows to the surface. Sections of the tubulars, commonly called “joints,” are joined by threaded connections. While the present invention has applicability in connection with the running of any tubular goods having threaded connections, for exemplary purposes the invention will be described in connection with a common use, namely the running of casing strings into the wellbore, where specialized casing handling tools are used.

Turning to the exemplary setting of running casing, it is common for specialized equipment to be brought to the well location to make up the threaded casing connections and run the casing into the wellbore. Such casing-related tools and equipment include, but are not limited to, power casing tongs which rotate the threaded casing connections to given torque requirements (such power tongs usually powered by hydraulic means, as well known in the art, frequently called hydraulic power units); casing elevators and spiders (which enable the lifting of individual joints of casing and/or the casing string in its entirety, and suspending the casing string from the rig floor, as is well known in the art), and associated smaller tools. Traditionally, such tools are carried together in one or more tool baskets, in turn carried on the back of a truck. The hydraulic power units are usually stand-alone units; that is, each power unit is on its own individual skid.

Typically, casing services are provided by a company separate from the drilling contractor. By “casing services” is generally meant the specialized crews and equipment needed to run casing, as described above, along with personnel having particular experience in handling casing (the entirety of the casing services often referred to as a “casing crew”). The casing services company is called to the wellsite when a casing string is to be run, and personnel and equipment go to the wellsite at that time. The casing tools generally arrive on a truck and must then be lifted off of the back of the truck with a forklift or crane, and placed where desired around the rig. Personnel must obviously climb onto the back of the truck to fix slings, etc. to enable offloading (and later onloading) of the casing equipment.

Various problems are associated with existing casing equipment and methods of transportation and deployment of same, in connection with casing jobs. Often, wells are drilled onshore with relatively rapid turnaround (in that the duration of the drilling of each open hole section is relatively short). Therefore, casing jobs may come up at short notice, and the operator of the well wants the needed equipment and personnel onsite when the casing job is to commence. However, despite all planning, unexpected delays occur, and the casing equipment may then sit unused at a wellsite for some time. With prior art practices, in order to satisfy the operator's desire to have equipment on site when needed, casing crew companies would frequently have to drive a truck to the wellsite, with all of the casing equipment loaded thereon, and leave the truck in at the wellsite until the casing job came up. As can be readily appreciated, this could result in the tie-up of a number of trucks (and associated equipment) while awaiting the casing jobs to come up.

Another issue is related to movement of the casing equipment from the back of the truck, which often required a forklift or crane. Many times, short-duration onshore wells may not have a forklift on location, so one either needed to be procured at short notice (with the attendant costs and problems of maneuvering a forklift on uneven ground) or other means provided to move tools from the back of the truck to a desired location on the ground. In addition, personnel must get on and off the back of the truck, which is elevated several feet above the ground, in order to attach and detach slings, etc. with the attendant potential for injury. Furthermore, since the casing equipment was typically not fully encompassed in a self contained skid or basket, offloading and loading simply took more time than was desired.

In view of the described limitations related to the prior art, it is desired to provide a system and method for oilfield service equipment transportation and handling, which minimizes or avoids the problems attendant with prior art methods and apparatus, particularly (although not exclusively) in conjunction with the provision of casing equipment (e.g. casing handling and running tools) and other tubular handling equipment on onshore wells.

### BRIEF DESCRIPTION OF THE DRAWINGS

FIG. 1 is a view of a truck and tool skid of the present invention, with the tool skid in a first position.

FIG. 2 is a view of the truck and tool skid of FIG. 1, with the arm of the tool skid handling assembly shown in an intermediate position and the tool skid partially moved off of the truck.

FIG. 3 is a view of the truck and tool skid, where the tool skid is moved further off of the truck.

FIG. 4 is a view showing the tool skid lowered completely to the ground.

FIG. 5 shows the arm of the tool skid handling system in further detail.

FIG. 6 is a view of the tool skid of the present invention, showing the placement of the various equipment and tools thereon.

FIG. 7 is a plan view of a typical wellsite layout, showing (in schematical form) the rig/well location, and placement of the truck/tool skid of the present invention.

### DESCRIPTION OF THE PRESENTLY PREFERRED EMBODIMENT(S)

With reference to the drawings, some of the presently preferred embodiments of the present invention can now be described. It is to be understood that various changes can be made to the invention, without departing from the scope thereof.

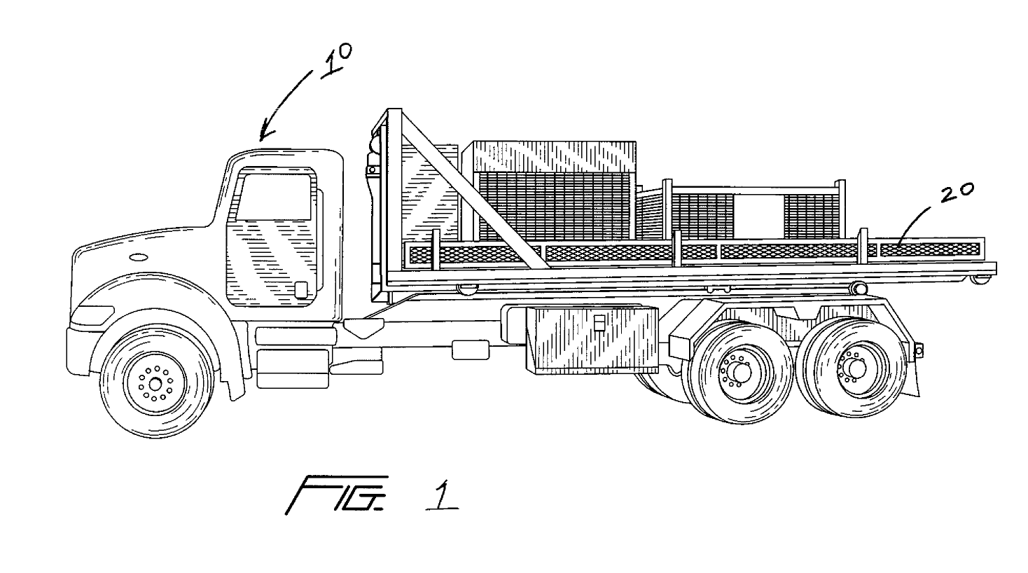

As can be seen in FIG. 1 (and the following figures), the system of the present invention comprises a truck 10 with a tool skid 20 adapted to be carried on the back of truck 10. Truck 10 is a highway legal vehicle having sufficient capacity to carry the fully loaded tool skid, along with several personnel, if needed.

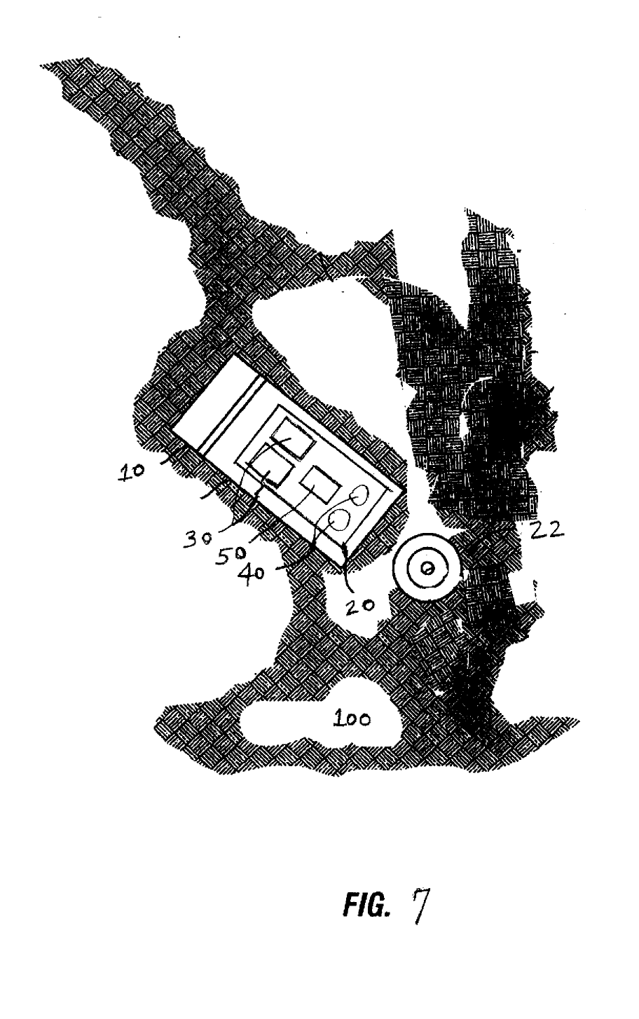

FIG. 7 shows an exemplary wellsite 100 where the present invention may be used. Truck 10, with tool skid 20 thereon (along with the various equipment carried on tool skid 20, as will be later described) is positioned in a desired location with respect to well 22 (which would also be the location of a rig, assuming that a rig is on the well). It is to be understood that tool skid 20 can thereby be moved to the ground, in a position rougly corresponding to the example shown in FIG. 7, or in another location. Multiple tool skids 20 could be placed at the site if desired.

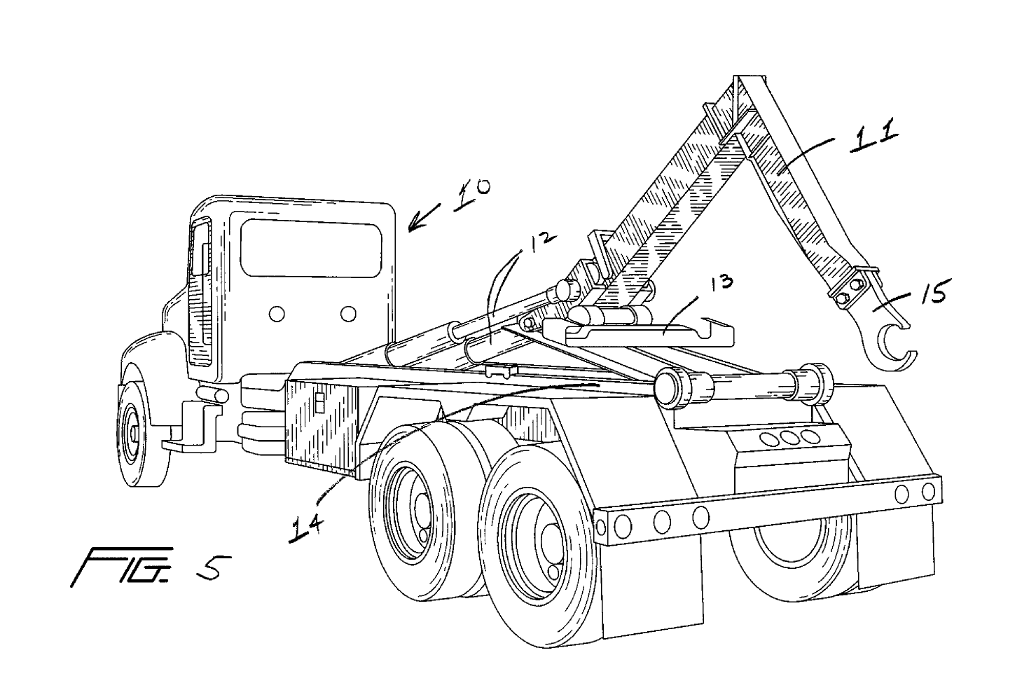

Truck 10 further comprises a tool skid handling system, comprising arm 11 and a means for moving arm 11, the means for moving arm 11 comprising one or more hydraulic cylinders 12. The means for moving arm 11 further comprises a carriage 13 on which arm 11 moves, carriage 13 in turn moving on rails 14 on the bed of truck 10. As can be seen from the drawings, in particular FIG. 5, arm 11 further comprises hook 15 affixed to the end thereof, for connection to tool skid 20.

The sequence of movement of tool skid 20 shown in FIGS. 1-4 will now be described. Starting from the position of FIG. 1, where hook 15 is engaged with a hook receiver 16 (which may comprise a loop or other shape which hook 15 can engage) on tool skid 20, extending hydraulic cylinders 12 first moves arm 11, and consequently tool skid 20, straight back toward the rear end of truck 10. Carriage 13 which at least partially supports arm assembly 11 then butts up against a stop on rail 14 on truck 10, where further rearward movement (that is, translation or straight-line movement rearwardly) of arm 11 is stopped.

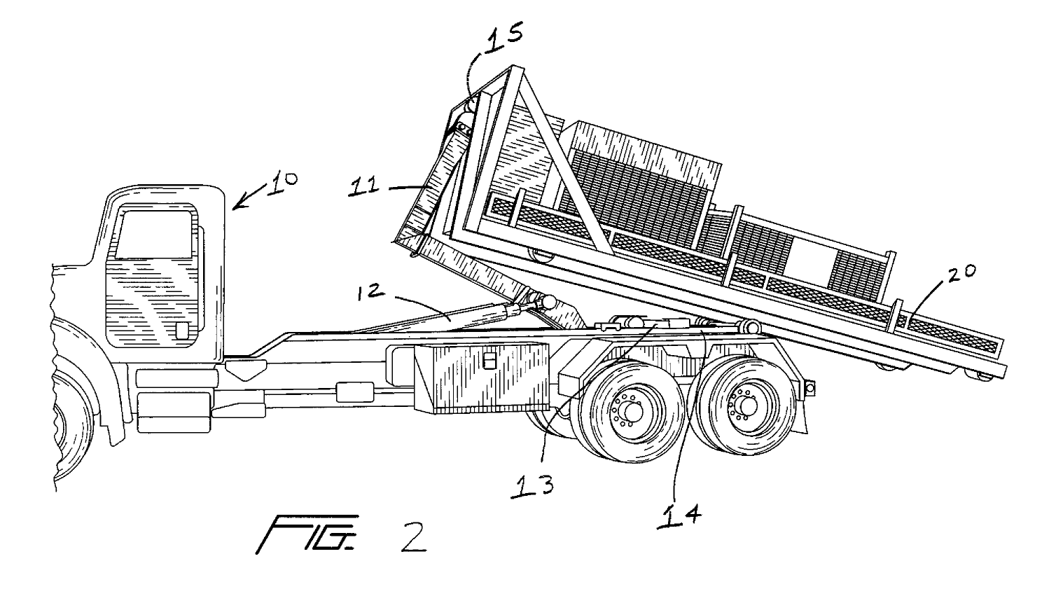

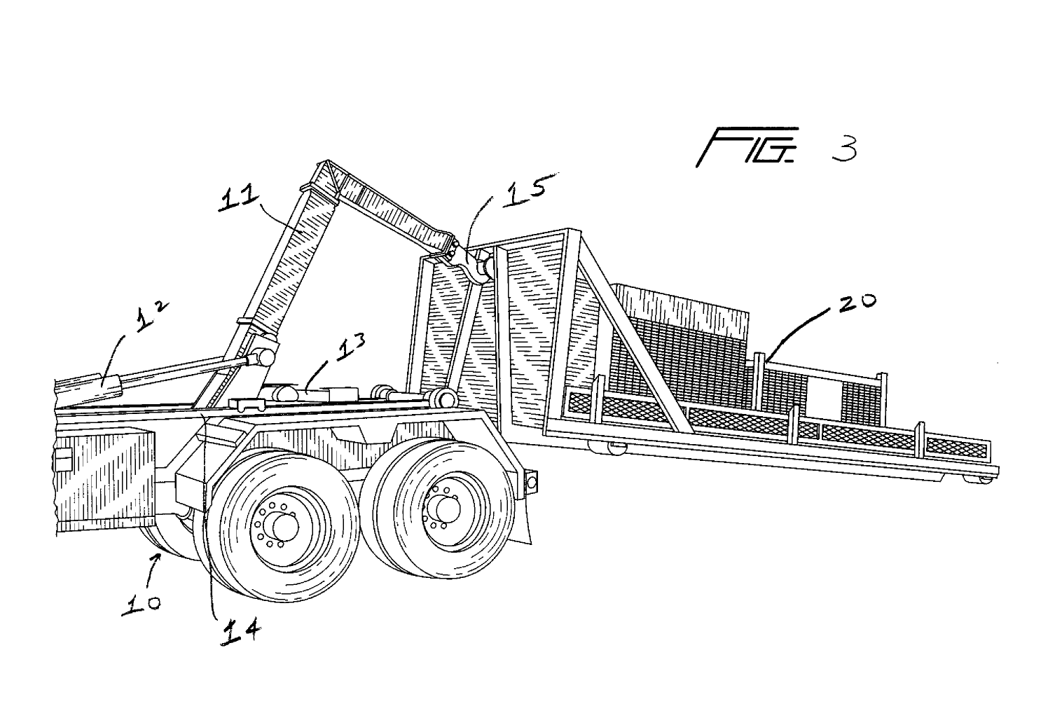

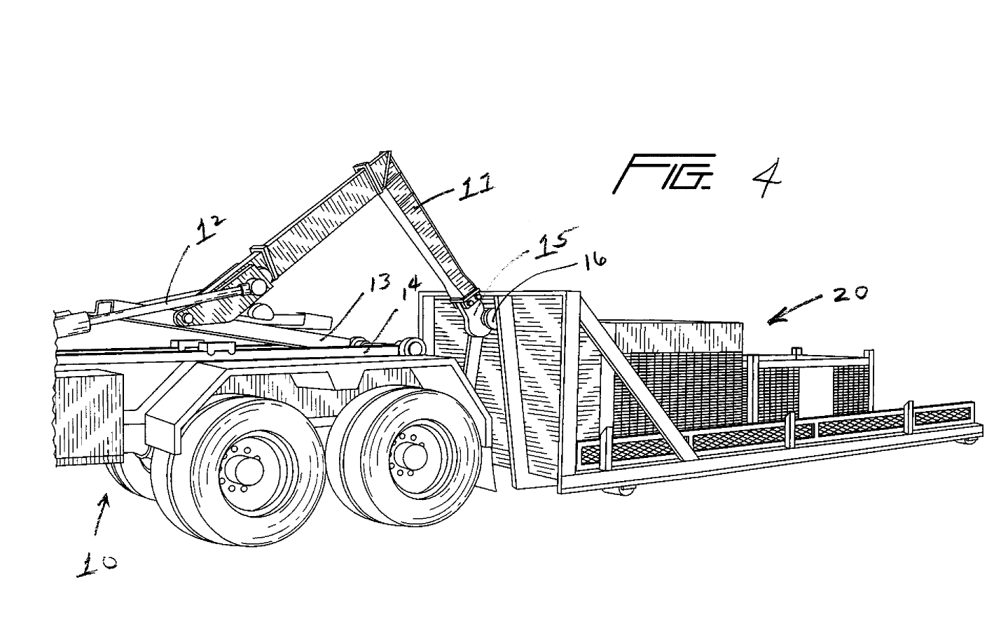

Continued extension of hydraulic cylinders 12 then begins to rotate arm 11 around a pivot point on carriage 13, as can be readily seen in FIG. 2. This rotation begins to lift arm 11, hook 15, and consequently tool skid 20. As a result, tool skid 20 is then partially lifted off of truck 10. As shown in FIGS. 3 and 4, continued extension of hydraulic cylinders 12 continues to rotate arm 11 and move tool skid 20 off of truck 10 and onto the ground, as shown in FIG. 4. Truck 10 can then move forward slightly, thereby disengaging hook 15 from tool skid 20. Hydraulic cylinders 12 can then be retracted to place arm 11 in its initial position, and truck 10 may leave the wellsite if desired.

When desired, and as can be readily understood from the foregoing description, the sequence of movement described above may simply be reversed in order to pick up tool skid 20 and load same onto truck 10.

The offloading and loading of tool skid 20 from and onto truck 10 may be carried out with only one person (typically, the same person that drove the truck to and/or from the wellsite) and done in very short time (for example, typically around one minute to offload the tool skid from the truck). In contrast to prior art practices, there is no need for personnel to climb onto the back of truck 10 to manipulate tools, slings, etc. in order to offload tools and equipment. To the contrary, the offloading and loading of tool skid 20 is done while the only person involved remains safely in the cab of the truck. Only after the tool skid is safely on the ground do personnel need to move onto same to handle the tools and equipment thereon. It should be noted that truck 10 can maneuver over even very uneven ground so as to place tool skid 20 in any desired location around the wellsite.

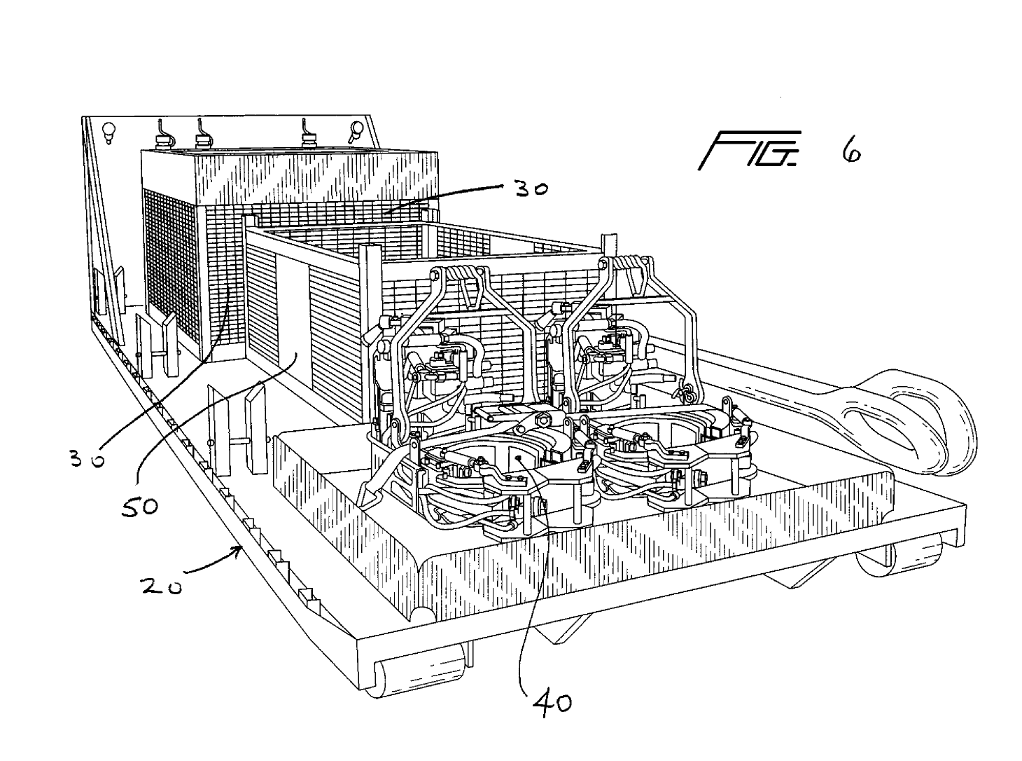

Tool skid 20 contains all of the casing-specific tools needed for a casing job. By way of example, and with reference to FIG. 6, tool skid 20 will typically have two hydraulic power units (engines plus hydraulic pumps) 30 needed to power casing tongs 40, which are also carried on the tool skid. Related equipment (casing elevators, hand tools, etc.) may be carried in a detachable basket 50. Still other equipment such as bails 60 (which suspend the casing elevators from the rig traveling block) are all also carried on the tool skid. All equipment and tools are properly secured via straps, hold downs, etc. on the tool skid so as to minimize or eliminate the possibility of equipment becoming unsecured and coming off of the skid. Tool skid 20 keeps all of the casing crew's equipment in a compact unit, rather than being in multiple locations across the location. It is preferred that power units 30 and tool skid 20 be configured such that the bottom of tool skid 20 forms as the bottom of power units 30, enabling multiple power units to be carried together in a much smaller “footprint” than if they were not made an integral part of the tool skid. In the preferred embodiment, tool skid 20 also comprises self contained lighting (which may be powered by batteries, the power units, etc.), for ease of working in low-light or dark conditions.

The truck (with only the driver) and tool skid can go to a wellsite at a convenient time before the casing job is planned to commence, and place the tool skid where desired. The driver can then return to a desired location with truck 10. The driver and the same truck 10 can, in similar fashion, deliver other tool skids to desired locations. Later, when the time of the casing job is at hand, casing crew personnel can travel to the job site in preparation for the job. Equipment on the tool skid that is needed on the rig floor (typically casing tongs, casing elevators, and casing spider, along with other associated tools) can be readily pulled up to the rig floor by a winchline from the rig. Power units 30 remain on tool skid 20, on the ground. Preferably, more than one hydraulic power unit is provided so as to provide redundant hydraulic power supplies for the casing tongs.

An exemplary method of transporting equipment to a wellsite and mobilizing same for future work, according to the present invention, comprises the steps of providing a truck having a tool skid handling system thereon; providing a tool skid, the tool skid having mounted thereon equipment for carrying out a desired job; securing the tool skid onto the truck; driving the truck to a wellsite; maneuvering the truck to a desired location at the wellsite; offloading the tool skid onto the ground, using the tool skid handling system of the truck; leaving the wellsite with the truck; returning to the wellsite at a desired time, with personnel needed for a job requiring the tools on the tool skid; and moving such tools as are required for the job, from the tool skid to the rig. Additionally, as described above, the method of the present invention may comprise the delivery and/or pickup of additional tool skids from additional wellsites, all with a single truck.

While the preceding description contains many specificities, it is to be understood that same are presented only to describe some of the presently preferred embodiments of the invention, and not by way of limitation. Changes can be made to various aspects of the invention, without departing from the scope thereof. For example:
the tool skid handling system may be hydraulically powered, or powered by other means such as electro/mechanical, pneumatic, or otherwise
the tools carried on the tool skid may be for the make-up/breakout of any threaded tubular, including casing, tubing, drill pipe, etc.; or may be for other types of work done in connection with the drilling, completing, and/or servicing of wells, such as cementing, acidizing, fracturing, etc.
the tool skid may have additional features such as a hold back winch, mounts for various equipment, lighting, etc.

Therefore, the scope of the present invention is to be measured not by the foregoing exemplary disclosure, but by the appended claims and their legal equivalents.

I claim:

1. A system for transportation and handling of oilfield service equipment, comprising:
a) a street-legal truck;
b) a tool skid comprising oilfield service equipment for specialized work, removably positioned on said truck; and
c) a tool skid handling system on said truck, said tool skid handling system operable by a single person to move said tool skid from said truck to a ground surface, and to move said skid from said ground surface to said truck.

2. The system of claim 1, wherein said tool skid handling system comprises an arm with a hook thereon, a means for moving said arm, and wherein said tool skid comprises a hook receiver.

3. The system of claim 2, wherein said means for moving said arm comprises a carriage supporting said arm, rails on said truck on which said carriage rides, and at least one hydraulic cylinder connecting said arm with said truck, wherein extension of said hydraulic cylinder moves said arm so as to move said tool skid from said truck to a ground surface.

4. The system of claim 1, wherein said tool skid comprises at least one hydraulic power unit, adapted to run power tongs for screwing and unscrewing threaded tubular connections.

5. The system of claim 4, wherein said tool skid comprises two or more hydraulic power units.

6. The system of claim 1, wherein said tool skid comprises lighting.

7. A method for carrying out a well servicing job, comprising the steps of:
a) providing a street legal truck comprising:
a tool skid handling system thereon, and
a tool skid removably positioned on said truck, said tool skid containing specialized equipment for a well servicing job;
b) driving said truck with said tool skid thereon to a wellsite where a rig is present;
c) with said tool skid handling system, moving said tool skid from said truck to the ground at a desired location at the wellsite; and
d) using rig equipment to move equipment from said tool skid to said rig.

8. The method of claim 7, further comprising the step of driving said truck away from said wellsite after moving said tool skid from said truck to the ground, and returning to said wellsite in a vehicle other than said truck to carry out said work.

9. The method of claim 7, further comprising the steps of:
departing said wellsite with said truck;
returning to said wellsite with a work crew;
performing the well servicing job; and
returning to said wellsite with said truck; and
moving said tool skid onto said truck.

10. The method of claim 7, wherein said truck delivers one tool skid to a first location, and moving said tool skid to the ground at said wellsite, the same truck transports a second tool skid to a wellsite, and moves said tool skid to the ground.
